(19) United States
(12) Patent Application Publication
(10) Pub. No.: US 2015/0102155 A1
(43) Pub. Date: Apr. 16, 2015

(54) ROAD-AND-AIR TRANSPORT VEHICLE

(71) Applicant: Ivan KRASTEV, Plovdiv (BG)

(72) Inventor: Ivan Krastev, Plovdiv (BG)

(21) Appl. No.: 14/402,156

(22) PCT Filed: May 30, 2013
(86) PCT No.: PCT/BG2013/000024

§ 371 Date: Nov. 19, 2014

(30) Foreign Application Priority Data
Jun. 7, 2012 (BG) 111231

(51) Int. Cl. B64C 37/00; B64D 17/80; B60L 7/10; B64C 3/56; B60K 16/00

(52) U.S. Cl. CPC B64C 37/00; B64C 3/56; B60K 16/00; B60L 7/10; B64D 17/80; B60K 2016/003
USPC 244/2

(57) ABSTRACT

The Road-and-air transport vehicle is intended to transport people (from 1 to 4 people] on the roads, as a light passenger vehicle, and in the air—as a small aircraft. It has a body (1] with a cabin (13), 4 wheels: 2 front wheels, controllable (2) and 2 rear wheels driven (48] by two electric motors (51,52), fitted to the wheel rims, or by the main back propeller engine (28)—electric or with internal combustion which has a variable vector of the propelling force—for a short landing strip and big maneuverability, as well as several wings: 2 front telescopic wings (5,7) and (11,14), with variable angle of attack for short take-off way and big maneuverability; 2 main movable wings (19,43), whole, with bent edges, folded to the body (when it is on the road), and unfolded (when the vehicle is flying), as by means of rotation by different devices they change their swept position during the flight, they have elevons (79) and rotating flaps (77), which increase their lifting force at taking off—for short drive take-off way, while during the flight they generate electricity; additional wings: 1 bottom wing (40), 1 upper wing (38) and 1 rear wing (33), carrying two vertical stabilizers (30,32 with steering wheels 84,85) connected fixedly by the upper back wing (31 with 2 horizontal steering wheels 86,87), forming the tailpiece. It is fitted with 2 propellers (27,35) or 2 turbine (58,59) electrical motors—generators, which during the flight produce electricity, but in case of fault of the main engine (28) they replace it—for the purpose of safe landing. For maximum safety the Road-and-air transport vehicle is fitted with a parachute module (75), which lands the whole craft. All external surfaces of the wings, the body and the cabin are covered with photovoltaic elements and together with the other generators they charge a unit of accumulators and capacitors. The Road-and-air transport vehicle is intended for mass use for personal purposes (flying cars) or for public (ambulances, taxis, postal carriers, police patrols, fire-department vehicles, for military and other) purposes.

### I. TECHNICAL FIELD

This invention is classified to the Road-and-air transport vehicles (RATV) and they are also known as “Flying automobiles” (FA) or as “road planes”.

Application: as mass personal and family transport vehicle, as well as public vehicle, such as emergency ambulance, taxi, police, fire-department, military patrols, etc.

### II. CURRENT STATUS OF THE TECHNOLOGIES

Model for comparison: W02012/012752, PCT/4S2011/04503.

There are several similar models, of which closest to the new transport vehicle, is the one with the above-stated patent which consists of:
1. Body
2. Wheels 4 (four): 2 (two) front wheels, controllable, and 2 (two) rear-drive wheels, each one of them covered by aerodynamic fairings.
3. Two wings, folding at 2 points (axes, transverse to the wings) along the length of each wing, as they can fold (unfold) perpendicularly to the longitudinal axis of the aircraft (body);

The wings folded to the body do not allow the existence of other doors (i.e. to understand more passengers), which is a disadvantage for the future developments, if the number of passengers is to be increased.
4. To rear inclined stabilizers (with vertical steering wheels for steering in the air, to the left/right)
5. Low positioned horizontal back wing, connecting with a joint the two inclined stabilizers.
6. Cabin—for two people, pilot-driver and 1 (one) passenger, with 2 (two) seats, dashboard and control tools, intended both for road and air.
7. Engine—petrol engine, mounted at the back of the body, with a propeller pushing the craft forward.

The folding of the wing at 2 (two) points is driven by a system of coils and a steel rope, which requires the existence of further 2 (two) locking systems, for each wing, which makes it unreliable for frequent use. The moving on the road is done by the two rear wheels, which receive their engine torque by the only engine (petrol engine), located at the back of the craft, by a system of a clutch, a gear-box and a differential, which is traditional for vehicles with rear-wheel drive, but this complicates the craft and makes it more expensive. It is lifted in the air with the help of a 1 (one) engine—petrol engine, coupled with a 4-leaf propeller. The wings are fitted with 2 (two) elevons each, for vertical steering—taking off (landing) or change of trajectory in the air (upwards/downwards).

### III. DESCRIPTION OF THE NEW INVENTION. TECHNICAL NATURE. AN EXAMPLE METHOD FOR ITS MAKING

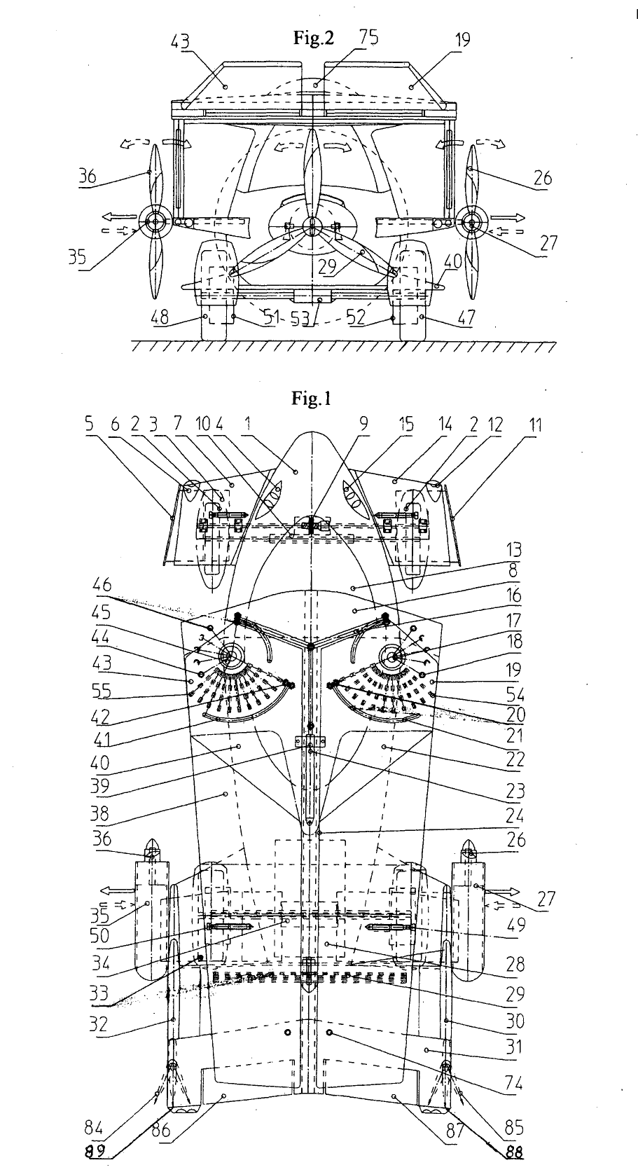

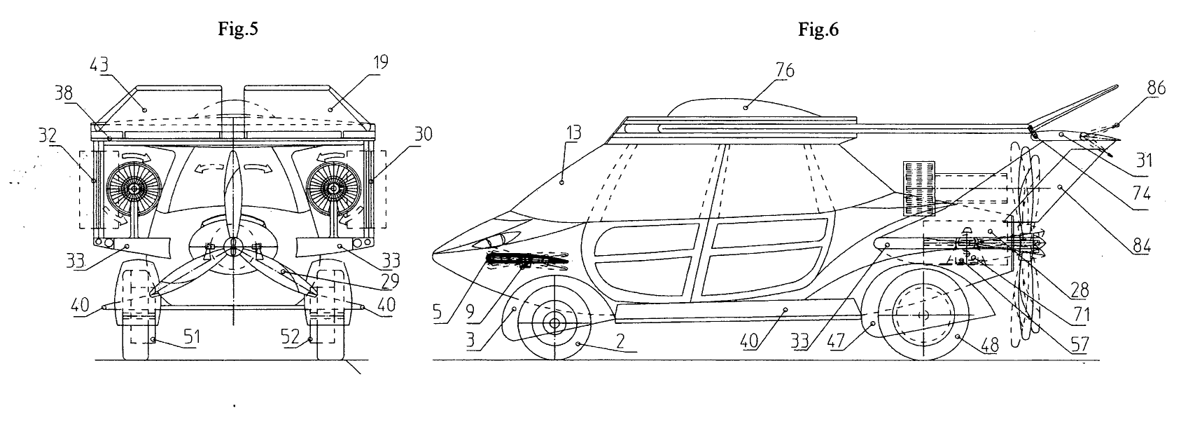

The road-and-air transport vehicle (RATV) called in short “Flying automobile” (FA) comprises of:
1. Body (pos. 1, FIG. 1)—with aerodynamic form, similar to this of the airplanes of light class, in a combination with elements of a light passenger vehicle.
2. Wheels 4 (four)—2 (two) front wheels (pos. 2, FIG. 1) positioned outside the body, covered with aerodynamic fairings (pos.3, FIG. 6), steered by the driver-pilot from the cabin,—2 (two) rear wheels (pos. 47, 48, FIG. 2, FIG. 6), positioned outside the body, driven by 2 (two) methods:
a) Traditional—mechanical—the wheels are driven by the main engine with internal combustion (pos. 28, FIG. 1,6) (petrol, diesel or gas), positioned at the back part of the body, coupled with a propeller (pos. 29, FIG. 2), 3-leaf or 4-leaf, by an electromagnetic clutch; by a gear-box (pos. 34, FIG. 1), differential (pos. 53, FIG. 2), break system and suspension, similar to the automobiles with rear-wheel drive, in a way that the two rear wheels receive the drive.
b) By means of 2 (two) electric engines—alternators, each one of them fitted to the wheel-rims of the two rear wheels (pos. 51 and 52, FIG. 2), as in this way several effects and advantages are achieved:
Ecological electric drive on one hand,
Without gear box (it is performed by the change of the rotations of the electric engine in an electronic way)
Without differential

Which generally reduces the weight and the price.
The breaks of the vehicle are connected to the device for transforming the released heat into electricity, which is especially felt while landing on a landing-strip, when the role of the breaks is most important.
3. Cabin (pos. 13, FIG. 1)—intended for 2 (two) or 4 (four) passengers, one of whom is the driver-pilot and 1 (one) or 3 (three) passengers or load. There is a variant with 2 or 3 persons and luggage, as well as a variant with 4 (four) or 2 (two) seats.

The cabin has dark windows—producing electricity (see the German Helitek), which are as one whole screen—comprising of the front fairing screen up to the rear window, thus allowing excellent vision both for the driver and for the passengers—in front, to the sides and backwards. There is a variant with glazing the ceiling above the driver, for visibility upwards as well.

The cabin has 4 (four) doors—2 (two) front and 2 (two) back doors, as each door is fitted with a dark glass, up to two-thirds of the surface (also producing electricity), which still further increases the visibility and the panoramic view of all passengers.

There is a control board for road movement (steering wheel, gear-box, sensors, etc.), as well as aircraft tools display with GPS, connection with the command centers, gears and control buttons, etc.

4. Front Wings:

In the front part of the craft, above the front wheels there are positioned 2 (two) front wings: left (pos. 7, FIG. 1) and right (pos. 14, FIG. 1), which are:
a) Telescopic (of 2 parts), in order to take the smallest possible space during moving on the road, and maximally expanded during the flight for bigger lifting force.

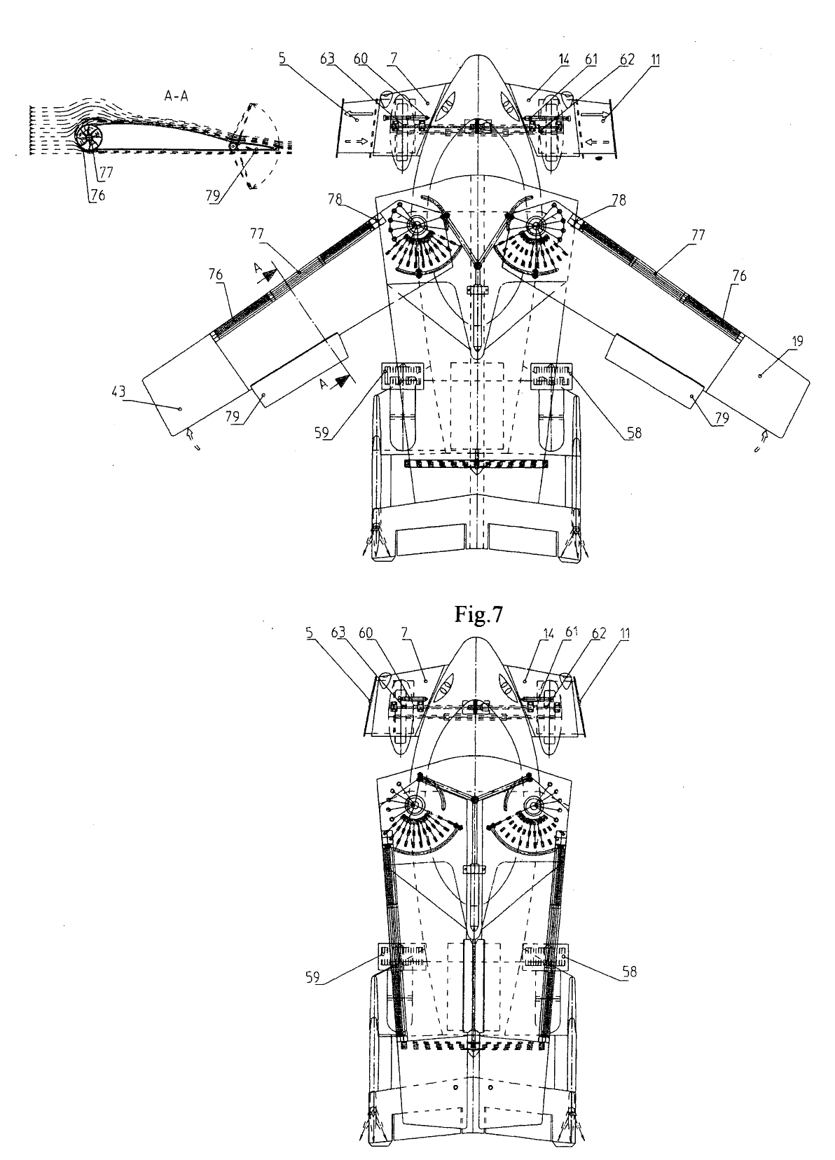

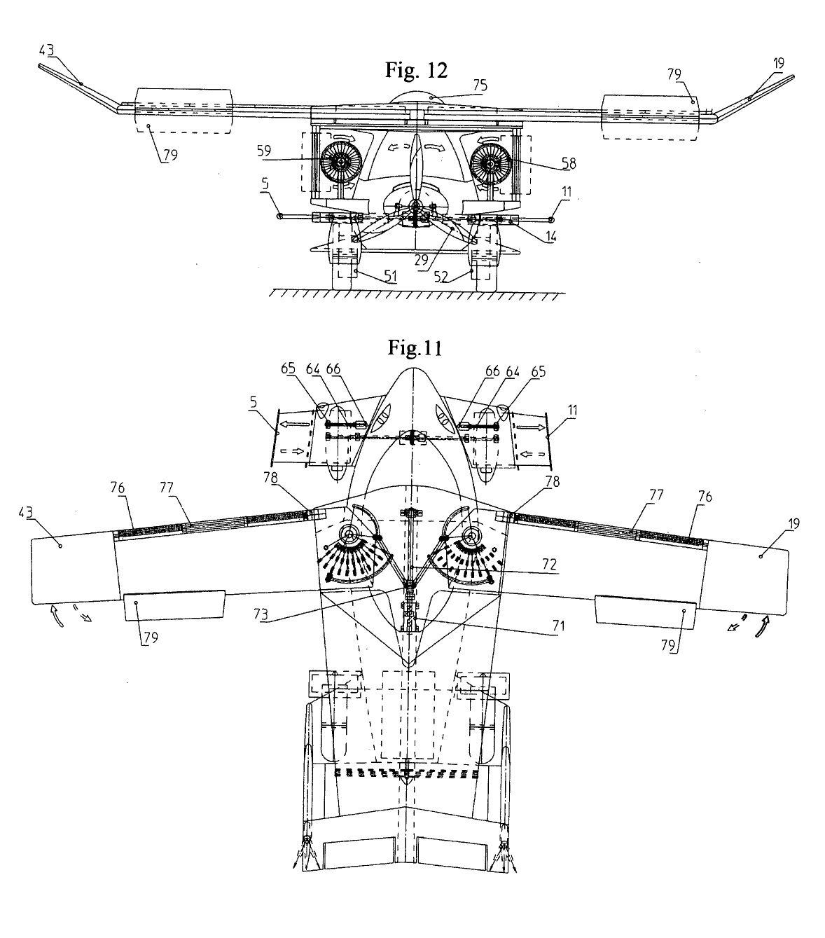

This movement can be done in two possible ways:
With 1 (one) hydrocylinder for each wing (pos. 60,61, FIG. 7,80
With one couple of balls screw-nut, driven by a worm reducer for each wing (pos. 64, 66, FIG. 11,15,16).
b) They can be turned to a certain angle, by transverse axles, driven by 1 (one) joint worm reducer (pos. 9, FIG. 1), under the command of the driver-pilot (around a horizontal axis), as in this way they increase the lifting force at taking off, as well as, as an additional steering for vertical movement during the flight—upwards and downwards.

5. Rear Wings and a Tailpiece:

In the rear part there are:
a) Main carrying rear wing (pos. 33, FIG. 1, FIG. 6, with trapezoid form), which carries:
b) 2 (two) vertical stabilizers (pos. 30,32, FIG. 1) connected in a fixed manner to this wing and carrying 2 (two) vertical wheels (pos. 82 and 84, FIG. 1,6), to which another wheel is fixed in a fixed manner:
c) Wing, back, upper (pos. 31, FIG. 1) which is part of the tailpiece and carries 2 (two) horizontal wheels (aerons) for steering in vertical direction:
d) 2 (two) elerons—(pos. 86,87, FIG. 1,6), fitted on the back upper wing (pos. 31, FIG. 1), which can be steered in a combined manner or separately for lifting up/lowering or turning. Such a structure of the tailpiece is very stable, as a four-wall box is formed in this way, on one hand, and on the other hand, inside this box the rear main propeller is rotated, so that this is a protective frame for the propeller.

6. Main Carrying Wings: (Pos. 19 and 43, FIG. 2,3,10,12,13,14).

These are 2 (two) large and long wings (left and right), which are movable, each—around 1 (one) vertical axis, which allows them to turn (around their axis) and to take different positions: folded wings, position parallel to the longitudinal axis of the craft—a position for movement on the road.

For ensuring the stability of turning, the craft uses a system of mechanisms including a bearing body (pos. 17,45, FIG. 1), radial rolls (pos. 54,55, FIG. 1), bolts pressing with bearings and sliders (pos. 42,20, FIG. 1) moving in radial canals (pos. 21,41, FIG. 1), around the rotation axes of the wings—the bearing bodies (pos. 17,45, FIG. 1).

When taking off, the wings, under the control of the pilot are rotated forwards and are positioned almost perpendicularly to the longitudinal axis of the craft (they are fixed automatically in this position). The wings are whole, while their edges are bent upwards under a particular angle (V-shaped) which helps for the centering and stabilizing of the aircraft during the flight.

They are with an aerodynamic profile—flat at the bottom and bulged on the top, with smooth lowering to the rear edge of every wing.

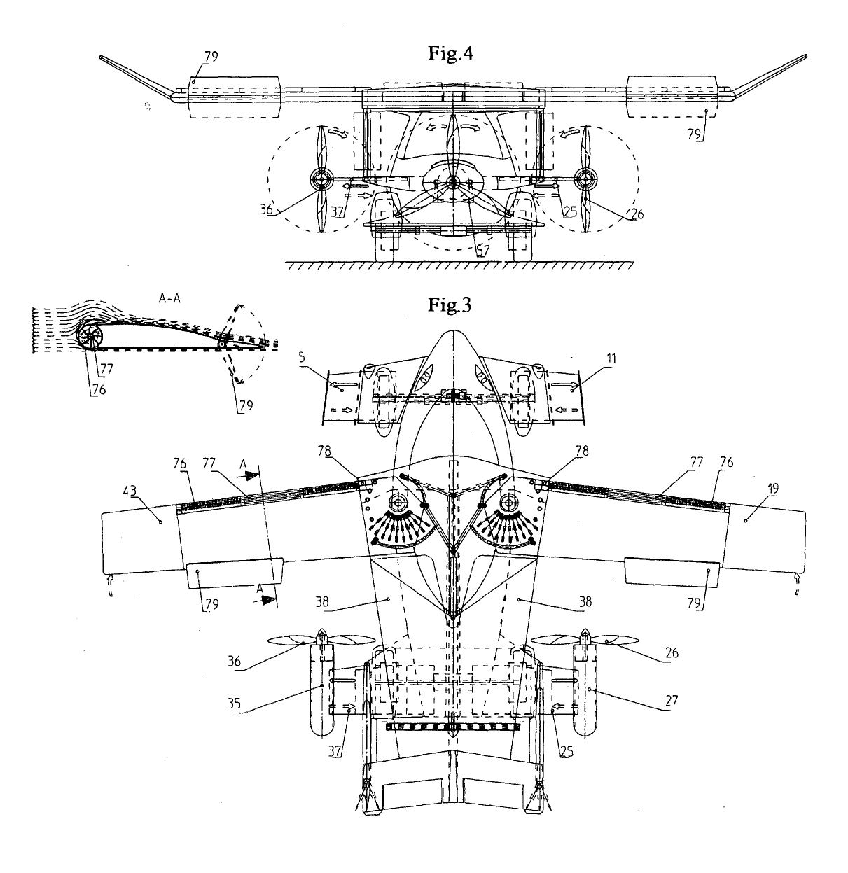

*A very important element is the presence of turning flaps (pos. 76,77,78, FIG. 3,8,10,13,15,16), fitted on the front edges of the both main wings, as this is one of the main variants of the wings' construction (there is also a variant without them, for the purpose of reducing the price and the weight).

They increase many times the lifting force of the wings, which allows for a very short take-off way and taking off at a much lower speed, and with less power of the main engine. Only 30-50 m of a landing-strip is required both for taking off and for landing, whereas at lower speed the aircraft can hang in one place as a helicopter. But this is not all: the rotor with the longitudinal propellers (pos. 77, FIG. 3,8,10,13,16), when taking off, is rotated by an electric engine/alternator, which after taking off is switched to alternator regime whereas under the impact of the cross air it is rotated and generates electricity necessary for the whole energy system, which provides electricity production enough to supply entirely the self-supply and providing an entirely autonomic flight without the need of external fuel or supply.

The wings are fitted with elevons (pos. 79, FIG. 3.4), which allow for better maneuverability, but also there is a version without them, with the purpose of larger stability and resilience of the wings and lower price.

When folded the wings are supported and fixed to the rear horizontal upper wing by 2 fixing clamps (pos. 74, FIG. 6) for their better stability, when the vehicle is on the road (or in the garage); the elevons (pos. 79, FIG. 3,4,8,9) should be in maximum upper position so not to touch the longitudinal beam (pos. 24, FIG. 1). The drive (rotating) of the wings is done in several possible ways:
a) By means of 1 (one) hydrocylinder (pos. 23, FIG. 1,3,7,8) and a lever system (pos. 16, FIG. 1) which pushes the wings and rotates them in order to move backwards (folded, FIG. 1,7) or to pull them out and rotate them (spread, FIG. 3,4,7,8), each wing around its own axis.

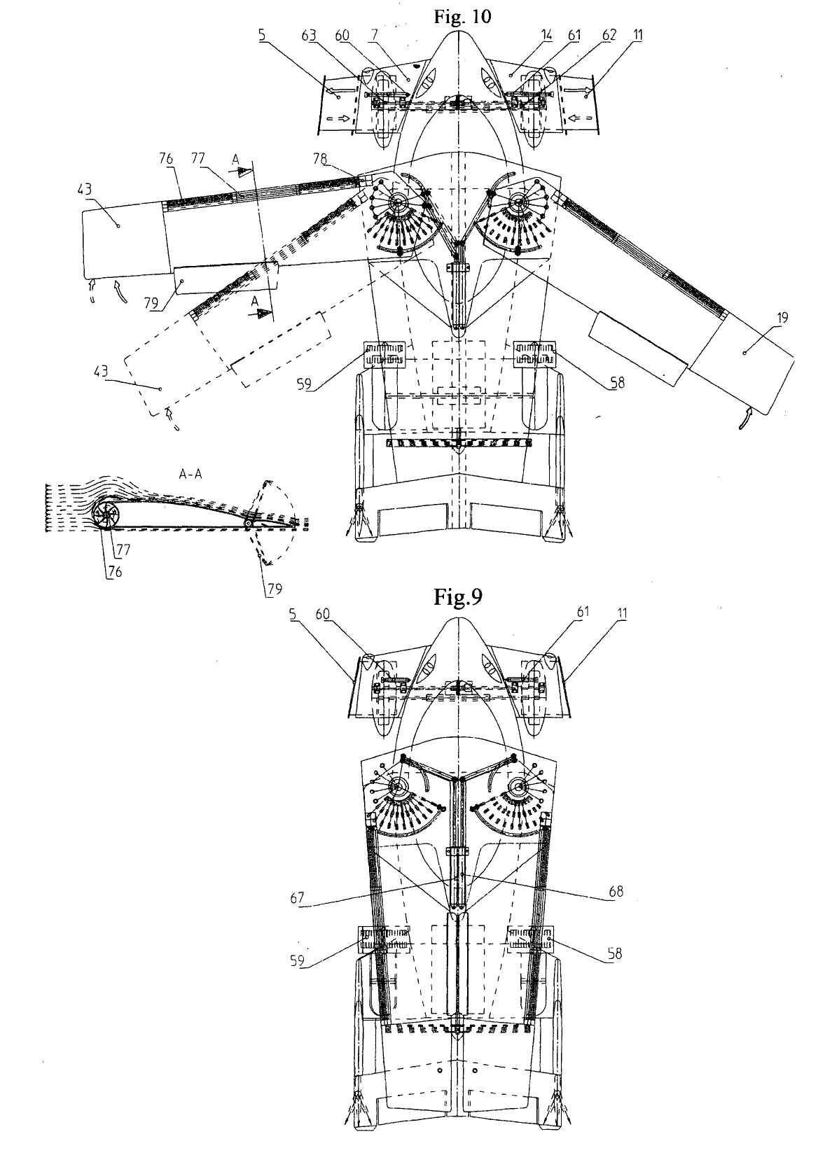

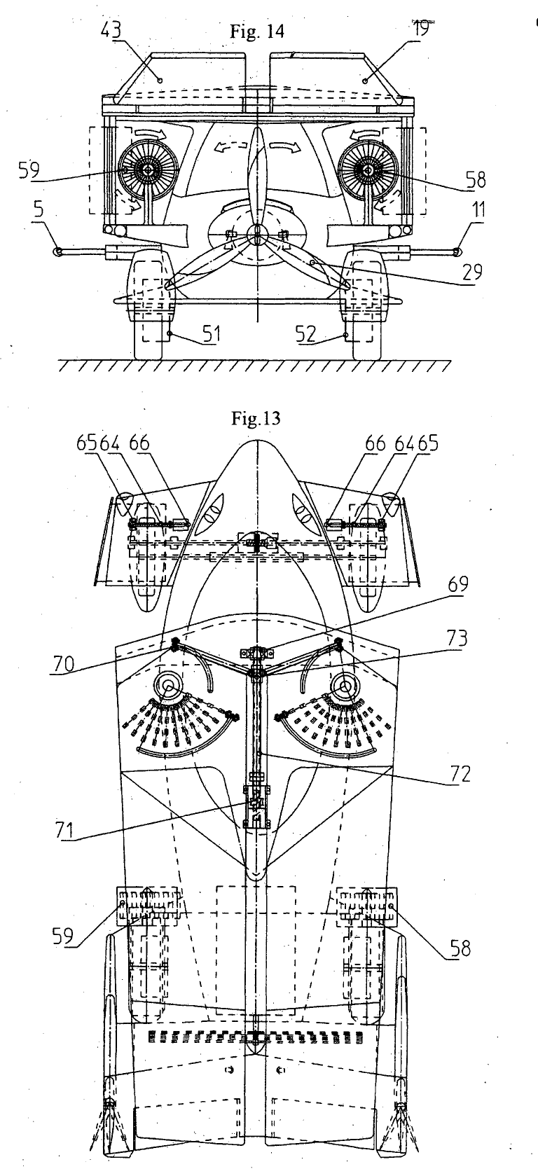

*A great advantage is that the swept ability (FIG. 8,10), i.e. the position of the wings can be changed during the flight by the pilot (or the autopilot), depending on the surrounding environment: strong wind, rain, etc., or with the purpose of a easier maneuver or for changing the speed.
b) by means of 2 (two) hydrocylinders (pos. 67, 68, FIG. 9,10) 1(one) hydrocylinder for each wing.
   this type of driving allows 2 (two) ways of unfolding/folding of the wings:
   synchronized opening/closing of both wings and taking the swept position of the wings set by the pilot.
   or separately one from another (FIG. 10), allowing the aircraft to make an abrupt maneuver (to the left or to the right) turning one of the wings more forward or more backwards compared to the other, taking an asymmetrical position (such a maneuverability is possessed only by birds).
   The hydrocylinders have (hydraulic) locking systems for blocking the position of the wings in case the supply is switched off by the pilot or due to a breakdown.
c) by means of 1 (one) ball couple screw-nut (pos. 69, 72,73, FIG. 13), driven by a worm reducer (pos. 71, FIG. 13).

This type of drive allows the opening-closing of the wings to be performed more precisely and in a synchronized manner and it is ensured twice, even if the drive system does not start—commanded so by the pilot or in case of a breakdown:
First, the nut cannot move if the screw is fixed and this ensures the fixed position of the wings
Second the worm reducer does not move if the supply has been stopped.

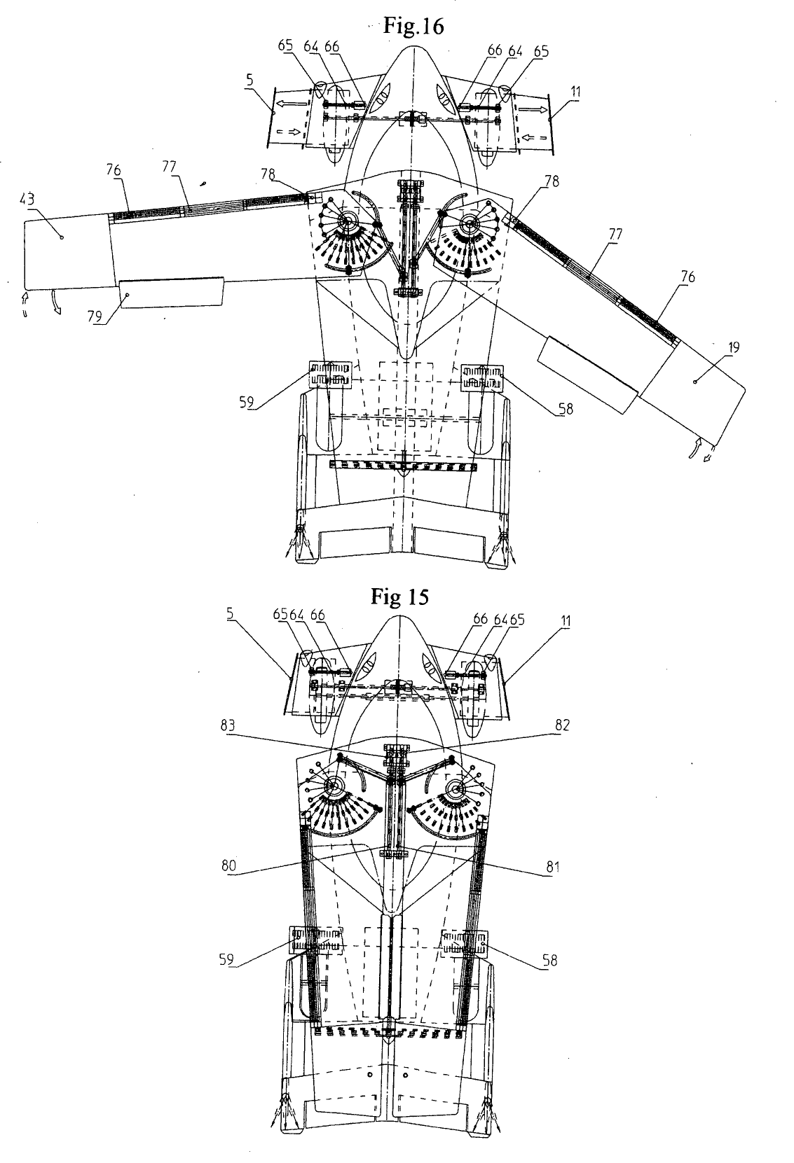

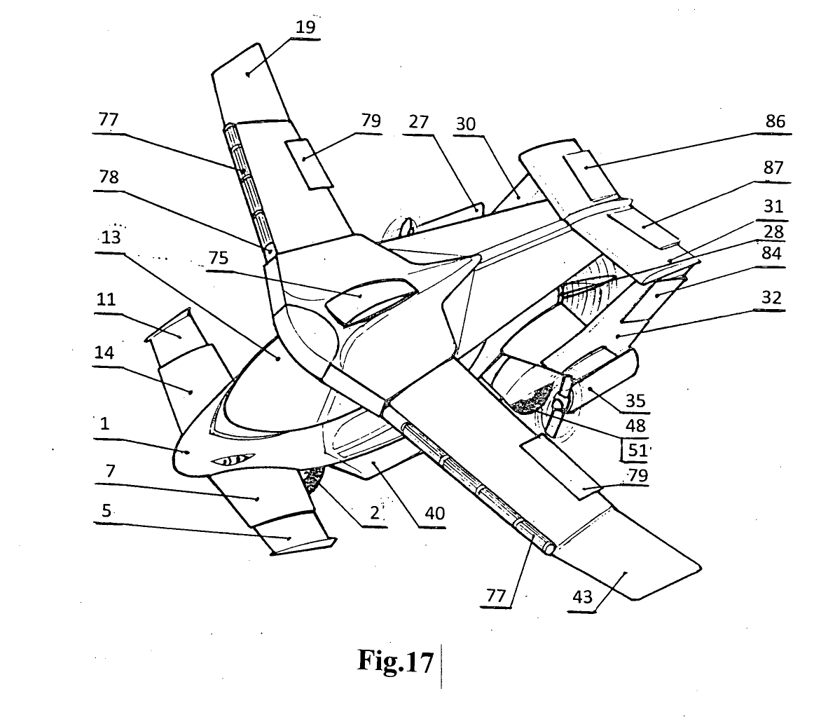

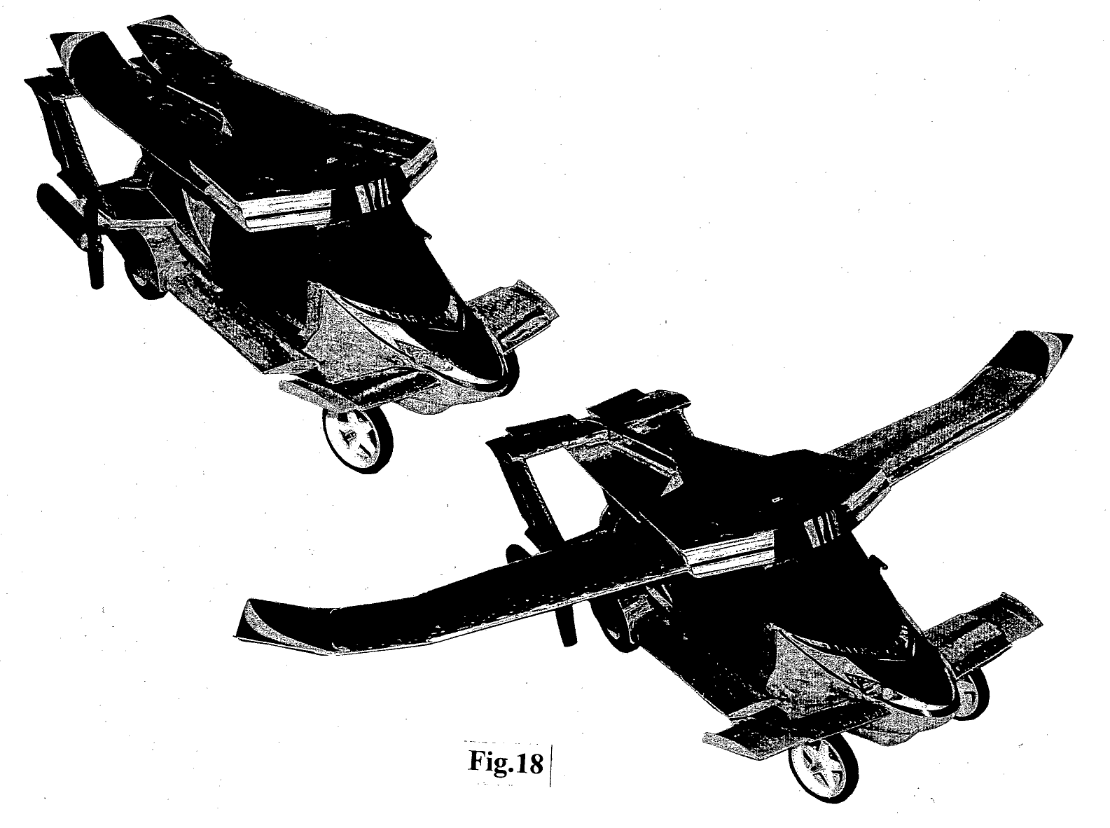

Thus, double security is achieved and protection of the position of the opened wings.
d) by 2 (two) couples of ball screw-nut (pos. 80, 81, FIG. 16), driven by two worm reducers (pos. 82,83, FIG. 15,16) which has the advantages of the ball screw-nut in a combination with a worm reducer, described above), and also it has the advantage for symmetric or asymmetric opening of the wings, described in subpoint b) (see above).

7. Main Engine (Pos. 28, FIG. 1, FIG. 6).

It is fitted at the back of the body and by means of a propeller pushes the vehicle forwards; it is possible to use several types of engines:
a) Internal combustion engine—one of the variants for improving the combustion is to use also hydrogen cells; the engine drives the main propeller (pos. 29, FIG. 2,5). It can be used in two possible ways:
Either only for flying, while on the road to move by 2 (two) electric-engines (pos. 51,51, FIG. 2), fitted to the wheel rims of the two rear wheels.
Or by an electromagnetic clutch to drive the propeller (pos. 29, FIG. 2,5) when flying, or the two rear wheels, as we already said, mechanically (by a clutch, gear box and differential).
b) Electric engine—in this case, additional sources of electricity are necessary, thus two power supply systems are present:
   A unit of batteries or accumulators (lithium-oxygen or other type) with great capacity;
   A unit of great capacity capacitors (tanks for the excess electricity).

For the purpose of maximal increase of the electricity production on board of the craft, all external surfaces, mostly all wings, as well as the body, are covered by photovoltaic elements (there are flexible batteries with thickness of 2-3 mm, developed in France and Switzerland).

The accumulator and capacitor unit can be powered also by the grid or by a ground station.

In both variants the engine is fitted on a special holder (pos. 57, FIG. 3,6), which allows its rotation around a horizontal axis, to a certain angle (downwards or upwards) by means of a worm reducer (pos. 71, FIG. 6) or by 2 (two) hydrocylinders. This rotation when commanded by the pilot (autopilot) is necessary for shortening the drive upon taking off, which is synchronized with the other wheels (elevons of the main wings (pos. 79, FIG. 8,10,13,16), the front wings (pos. 7,5,11,14, FIG. 1) and the elerons) on the rear upper wing on the tailpiece (pos. 86,87, FIG. 1,6).

8. Additional Engines/Alternators—Left and Right.

Here are two types of engines-alternators performing 2 (two) functions:
a) Electric engines moving 2 propellers (pos. 26,27,35,36, FIG. 1,2).
   First function—during flights these alternators (generators, dynamo) are driven by the propellers, by the cross air, and produce electricity necessary for the power supply of the accumulators, and mostly for the main electric engine, as well as of the control panel, the air-conditioning, ventilation, radio, video, GPS and other systems.
   Second function—this is the safety of the people on the board. During the flight the alternators are switched automatically or (manually) into electric engines, which in case of stoppage of the main engine, switch on and replace it for the purpose of safe landing of the Road-and-air craft.

The rotation/in opposite directions/of the two propellers (pos. 26,36, FIGS. 3 and 4), one per each engine (pos. 27 and 35, FIG. 1,3) requires telescopic carriers-wings (pos. 25,27, FIG. 3), to the rear carrying wing (pos. 33, FIG. 1,6) for the purpose of taking minimal width space while moving on the road, and to spread well in order to provide space for the propellers during the flights.
b) Turbine electric engines/alternators (pos. 58,59, FIG. 7,8) which have the same functions as the previous 2 (two) engines (see a), but they are more compact and they do not require telescopic wings.

This is a variant which uses two turbine engines-alternators, one to the left and one to the right (pos. 58,59, FIG. 7,8), fixed to the rear carrying wing (pos. 33, FIG. 6,1) between the two vertical stabilizers (pos. 30,32, FIG. 1,5,12). This structure has a smaller overall width compared to the previous variant (a), which is important for the vehicle when performing as a road vehicle or when entering a garage.

9. Wing, Intermediary, Central, Upper (Pos. 38, FIG. 1,3).

It is fitted with the purpose of increasing the lifting force of the aircraft, a wing with trapezoid form, connecting the main wings with the tailpiece, i.e with the rear upper wing (pos. 31, FIG. 1,6). Thus the structure becomes more stable, whereas along the longitudinal axis, at the level of the main wings and the rear upper wing (on the tailpiece) there is a traverse (pos. 24, FIG. 1) which supports the upper winged part of the aircraft and the structure as a whole.

This wing has a second function as well—it is covered with photovoltaic elements at the top and the bottom side, which increases considerably the surface producing passive electricity.

10. Wing Lower, Bottom (Pos. 40, FIGS. 1 and 6).

It serves for the increase of the lifting force (while preserving the existing dimensions of the road transport vehicle), it is fitted to the bottom, under the flat bottom, which comes out in one line with the folded main wings, while looking from above they coincide (FIG. 1,7,9), and in the same time the part that protrudes outside the body serve as steps for getting on and getting out of the passengers from both sides of the craft. In this way the lifting force of the wings is increased twice in total, which adds to the flying properties of the aircraft and shortens in double the drive way/landing of the aircraft.

11. Parachute Module (Pos. 75, FIGS. 2 and 6)

On the roof, adjacent to the vertical axis of the aircraft there is fitted an emergency parachute for the whole aircraft together with the passengers which is turned on automatically or manually by the pilot, in case of stoppage of all engines and the rotating flaps in case of a breakdown.

### IV. DYNAMICS OF THE ROAD-AND-AIR TRANSPORT VEHICLE WHILE IN MOTION

### 1. Moving on the Road—the Vehicle has Minimal External Dimensions.

a) With the main engine—in case of using this engine for 2 (two) purposes: the main propeller (at the back) is switched off by a clutch and by the gearbox and differential, the two rear wheels receive the torque moment.

The Road-and-air transport vehicle starts forwards and backwards: comes out of the garage or parking.
b) With the two electric engines—fitted in the wheel rims of the two rear wheels, the vehicle moves forwards and backwards, commanded by the driver. At this stage the main wings are folded and fixed parallel to the longitudinal axis. The front telescopic wings are folded. The wheel steers the front two wheels for turning (to the left/right), the rear wheels can be steered as well by setting different rotations, for further maneuverability as a motor vehicle.
   In the front part of the body the main lights are fitted (pos. 4,15, FIG. 1) of the vehicle, while the rear lights (pos. 88,89, FIG. 1) are fitted to the rear carrying wing (pos. 33, FIG. 1).

The propeller remains fixed. The propellers of the two auxiliary engines (generators) are fixed and maximally folded to the body (in the variant with two screw-engines) fitted on the telescopic wings.

### 2. Flight:

a) Taking off: the Road-and-air transport vehicle accelerates to a certain speed at which the main engine turns on; the rear propeller pushes it forward and in the same time the main wings unfold to their maximum unfolded state. The front telescopic wings also unfold to their maximum. The main engine bends backwards and downwards and the propeller rotates downwards towards the landing strip, with maximum rotation rate, commanded by the pilot, so thus the lifting force increases, which considerably shortens the acceleration drive; synchronized with this movement of the main engine, the two front wings are inclined upwards, thus the lifting force is further increased. The rear aerons (pos. 86,87, FIG. 6), fitted on the rear upper wing (pos. 31, FIG. 1) of the tailpiece are directed upwards, which also helps for increasing the lifting force, the elevators (pos. 79, FIG. 3,8,9) of the main wings are lifted upwards thus further increasing the lifting force.
In the same time the engines start rotating at maximum rate (pos. 78, FIG. 3,8,10) of the rotating flaps (pos. 77, FIG. 3,8,10) thus the lifting force reaching its peak (see section A-A, FIG. 3). At this moment the Road-and-air transport vehicle leaves the ground and flies with a minimum drive way (from 30 to 50 m, depending on the power).
b) Flying:

The steering upwards and downwards is done in the way described above. Turning left and right is done by the two steering wheels, positioned on the two vertical stabilizers. A sudden turn is possible in case of the variant with separate drive of the main wings—one of them is folded more to the back and the Road-and-air transport vehicle turns, just like birds.

During the flight the force of the surrounding airflow is used for the purpose of turning (in opposite directions) of the two auxiliary electrical engines (propeller or turbine) with the purpose of producing electricity which charges the units with lithium-oxygen (or more powerful) batteries and the units of the high-capacitive capacitors.

The cross airflow rotates the rotating flaps of the main wings which produce additional electricity with the alternators-engines.

The swept state of the main wings (the extent of unfolding) can be changed during the flight under the control by the pilot (autopilot) depending on the atmospheric conditions (wind, storm, rain) or regulating the flight with minimum energy consumption.

All photovoltaic surfaces produce electricity from the light and the sun and thus also charge the batteries and the capacitors.

### 3. Landing

For the purpose of lowering towards the landing strip, the same commands are applied by the pilot (autopilot) and the respective devices but in reverse order.

The rotation rate of the main engine is reduced. The main wings are maximally unfolded, and their elevons (pos. 79, FIG. 3,8,10,110 are directed downwards, the front wings are also maximally unfolded, turning downwards, while the main engine is inclined upwards and directs the propeller upwards (the vector of the torque is directed backwards and upwards), the aerons of the tailpiece are turned downwards. The flaps are rotated by their engines at maximal rotation rate for maximal lifting force for minimal speed of the aircraft, i.e. the shortest landing way.

First the rear wheels contact the landing strip, and then the front wheels. After activating the breaks, the main engine is turned at reverse rotation (reversing) and in the same time both auxiliary engines are switched to reverse direction (reversing).

Note: In case of breakdown during the flight, stoppage of the main engine, the two auxiliary engines and the engines of the flaps are turned on. In case of any of these engines does not start, then the parachute system for emergency landing is turned on for the whole aircraft together with the passengers.

4. Driving on the Road

All wings are folded in reverse order compared to that of taking off; all road systems are switched on.

It is possible to charge the accumulators on the mains power supply in the garage or on electrical power station on the road.

### V. ADVANTAGES OF THE INVENTION

1. The main wings are whole, with high level of resilience and toughness, they have aerodynamic profile and V-shaped bending of the edges for the purpose of stabilizing the flight.
2. The presence of rotating flaps considerably increases the lifting force and shortens the drive way and the landing.
3. The wings are turned to a certain angle only around 1 (one) axis, they are firmly fixed to the carrying roof plate at three points which gives stability and reliability of the structure. The above-described possible ways of steering the wings, especially the possibility for non-synchronized folding or unfolding of one of the wings independently from the other provides unseen possibilities for maneuverability; the flaps, the elevons, the aerons, the wheels make the Road-and-air transport vehicle extremely maneuverable during the flights. These abilities are unique for an aircraft.
4. The electric drive of the rear wheels reduces the weight of the aircraft thus making it in the same time very maneuverable when driving on the road. All the more, it is possible the rear wheels to rotate at different rates which gives exceptional maneuverability on road turns.
5. The steering system of the wings (the front and the main), as well as the variable vector of the torque, in combination with the increased surface of the wings allow the achievement of exceptional characteristics during the flight.
6. The presence of a parachute unit increases the passive safety of the flight of the aircraft and of the passengers. This combination of active and passive safety of the reserve engines and the rotating flaps makes this invention of a Road-and-air transport vehicle, the safest one in its class.
7. The use of additional electric engines—generators of electricity and the capacity of the contemporary photovoltaic surfaces, as well as the use of the rotating flaps for producing electricity, as well as the device for transforming the energy of the breaks into electricity, are e prerequisite for reducing the harmful emissions released into the environment and mostly the achievement of energy autonomy and flying without fuel—which gives endless capacity to fly to far destinations without external charging, without harmful emissions, even without noise.

1. The Road-and-air transport vehicle includes body, cabin, four wheels, two front controllable with fairings and two rear, driving, with fairings; there is one main engine, positioned at the back, with a propeller, tailpiece —includes two vertical stabilizers with two steering wheels, a rear wing and two main movable wings, characterized with the fact that the main wings are moving backwards and forward by rotation (each one around and axis), they are whole (with V-shaped edges), which are driven by different mechanisms—by a joint hydrocylinder or two separate (one for each wing) hydrocylinders, or by one or two ball couples screw/nut (one for each wing), with one or two worm reducers and can have rotating flaps with movable grates and two (one for each wing) electrical engine/generator and can have elevons; it has two front telescopic wings driven either by two hydraulic cylinders or two ball couples screw/nut with worm reducers, these wings have a mechanism for changing the angle of attack; the vehicle has one main rear engine, with a propeller, in several variants: electric or with internal combustion, with mechanism for changing the torque vector; the vehicle has two additional electric engines/generators with propeller, fitted telescopically by means of two wings, or turbine engines, fixed to the rear wing, carrying also two vertical stabilizers (with two steering wheels), which are connected in a fixed manner by the rear upper wing (with two horizontal steering wheels); it has an upper central wing, as well as a bottom wing; all external surfaces of the vehicle are covered by photovoltaic elements generating electricity, as well as the glasses of the cabin and the doors (two or four), all these charge a unit of accumulators and unit of capacitors (these units can be powered also by external electricity grid or electricity power station on the road}; the drive of the rear wheels is performed by the main engine or by a transmission or directly by two electric engines/generators fitted in the wheel rims and devices transforming the break energy into electricity; the vehicle is fitted with a parachute module for emergency landing of the whole aircraft together with the passengers.

2. The Road-and-air transport vehicle according to claim 1 has two movable main wings, characterized with the fact that they have upwards bended edges (V-shaped), rotating backwards (when it is on the road) or forward (during the flight), each wing around one axis (bearing body), by lever mechanism or two hydrocylinders (one for each wing) with hydraulic locking of the position, allowing changing swept position during the flight, symmetric (with one hydrocylinder) or symmentric and asymmetric (with two hydrocylinders).

3. The Road-and-air transport vehicle according to claim 1 has two movable main wings, which are rotated by a lever mechanism with one couple ball screw/nut and two work reducers, allowing changing swept position during the flight, symmetric (with one couple screw/nut) or symmetric and asymmetric (with two couples screw/nut).

4. The Road-and-air transport vehicle according to claim 1 has two moving main wings, which are whole, with edges bent upwards (V-shaped), with elerons (elevons) controlled separately or together.

5. The Road-and aircraft according to claim 1 has two movable main wings, which slide (while rotating) on radially positioned rolls and they are pressed to them by a mechanism of two bolts, with bearings and sliders, moving along arched canals 24.

6. The Road-and aircraft according to claim 1 has two movable main wings which can have rotating flaps with a rotor and propellers (increasing the lifting force), with movable grates and electrical engine/generator for each wing, which work as engines only upon taking off, together with the main engine, or as generators of electricity, during the flight, driven by the cross airflow, while the movable protective grates regulate the access of the airflow.

7. The Road-and-air transport vehicle according to claim 1 has four wheels fitted outside the body, two front, controllable, with fairings and two rear driving with fairings, which receive the torque from the main engine (with internal combustion) by a transmission (gearbox, differential, etc.).

8. The Road-and aircraft according to claim 1, has four wheels, fitted outside the body, which rear driving wheels receive the drive from two electrical engines/generators, fitted in the wheel rims.

9. The Road-and-air transport vehicle according to claim 1, has four wheels fitted outside the body, two front controllable, two back driving, receiving the torque from two electrical engines/generators, fitted in the two wheel rims, and the latter serve as generators turning the energy of the breaks into electricity.

10. The Road-and-air transport vehicle according to claim 1, has one main rear fitted engine, and this engine is with internal combustion, transferring the rotation by means of a clutch directly to the propeller (during taking off and during the flight) or to the two rear wheels (when driving on the road), by means of a transmission (gearbox and differential).

11. The Road-and-air transport vehicle according to claim 1 has one main rear fitted engine, which is with internal combustion and it transmits the rotation directly to the propeller. It is fitted on a frame, allowing it to rotate around its horizontal axis by means of a work reducer or other mechanisms for changing the vector of the torque.

12. The Road-and-air transport vehicle according to claim 1 has one main rear fitted engine, and this is an electrical engine transmitting the rotation directly to the propeller, fitted on a frame, allowing it to rotate itself around the horizontal axis by means of a worm reducer or other mechanisms for changing the vector of the torque.

13. The Road-and-air transport vehicle according to claim 1, has a tailpiece, which includes a rear wing, carrying two vertical stabilizers, with two vertical steering wheels, connected in their upper part, in a fixed manner by the upper rear wing (with two horizontal steering wheels), forming a special frame of four walls, surrounding the rear propeller and serving as a protective frame.

14. The Road-and-air transport vehicle according to claim 1, has central upper wing, which is fixed and it connects the cabin with the tailpiece (supported by a longitudinal beam), by increasing the wing surface and the lifting force.

15. The Road-and-air transport vehicle according to claim 1, has one bottom wing, which increases the wing surface and the lifting force and serves as steps for getting into the cabin.

16. The Road-and-air transport vehicle according to claim 1, has two front wings, which are telescopic and they are folded to the body (when the craft serves as an automobile) or they are unfolded transverse to the body (when taking off and during the flights), by two hydrocylinders (one for each wing), with hydraulic locking system.

17. The Road-and-air transport vehicle according to claim 1, has two front wings, telescopic, folding to the body (when it is an automobile) or they are unfolded transversely to the body (when taking off or during the flights), which are driven by two ball couples screw-nut (one for each wing), by means of two worm reducers.

18. The Road-and-air transport vehicle according to claim 1 has two front wings, telescopic, which can rotated around the horizontal axis by two semi-axes, driven by worm reducer, for change of the angle of attack of the front wings.

19. The Road-and-air transport vehicle according to claim 1 has two additional electrical engines/generators, which have propellers, while the engines are fitted, able to move, by telescopic wings, by means of two hydrocylinders, and they are folded in the rear carrying wing (while on the ground road] or they are unfolded (when taking off or during the flight)

20. The Road-and-air transport vehicle according to claim 1 has two additional electric engines/generators, which are turbine, fixed on the carrying wing (between the two stabilizers).

21. The Road-and-air transport vehicle according to claim 1 has two additional electrical engines/generators, which work as generators of electricity during the flight 9 when they have propellers) or during the flights and driving on the road (when they are turbine), and they charge with electricity the unit of accumulators and capacitors.

22. The Road-and-air transport vehicle according to claim 1 has two additional electrical engines/generators, which work as reserve engines (in case of stoppage of the main engine) together or separately from the electrical engines of the rotating flaps of the main wings.

23. The Road-and-air transport vehicle according to claim 1, has a cabin, with dark glasses (in front, to the sides and back), as well as two or four doors, with ⅔ of their surfaces are dark glazed; as the glasses have two functions—visibility to all sides and generators of electricity, as they are photovoltaic elements.

24. The Road-and-air transport vehicle according to claim 1 has a cabin, which roof above the pilot can be transparent.

25. The Road-and-air transport vehicle according to claim 1 has a parachute module, which in case of emergency or stoppage of all engines is activated automatically or manually, ensuring the safe landing of the transport vehicle/aircraft, together with its passengers.

26. The Road-and-air transport vehicle according to claim 1, all external surfaces of the wings, the body, the cabin and the glasses are covered by photovoltaic elements which generate electricity by transforming the light and the solar energy.

27. The Road-and-air transport vehicle according to claim 1 has two main wings with elevons/aerons/, with variable swept position during flights (symmetric or asymmetric), rotating flaps, one main engine with variable torque vector, two front wings, with changing angle of attack, two additional electrical engines, two vertical steering wheels, two horizontal steering wheels (aerons), and all these devices for flight control can be used separately or in a combined manner.

28. The Road-and-air transport vehicle according to claim 1, has active (electricity generators) and passive (photovoltaic elements), which are sources of electricity, fitted on board, and they charge with electricity units of accumulators and capacitors and provide full autonomy during the flight, but they also can be charged from the grid or from road power stations.
